(19) United States
(12) Patent Application Publication
(10) Pub. No.: US 2023/0092877 A1
(43) Pub. Date: Mar. 23, 2023

(54) CHEMICAL RECYCLING METHOD FOR POLYESTER BASED TEXTILE AND/OR PACKAGING WASTE

(71) Applicant: SETAS KIMYA SAN. A.S., Istanbul (TR)

(72) Inventors: Ahmet Celalettin TURAN, Istanbul (TR); Erhan GÜLEKOGLU, Istanbul (TR); Hüsnü Kemal GÜRAKIN, Istanbul (TR)

(21) Appl. No.: 17/904,236

(22) PCT Filed: Aug. 20, 2020
(86) PCT No.: PCT/TR2020/050727

§ 371 Date: Aug. 15, 2022

(30) Foreign Application Priority Data
Feb. 17, 2020 (TR) 2020/02388

(51) Int. Cl. C08J 11/16

(52) U.S. Cl. CPC C08J 11/16; C08J 2367/02

(57) ABSTRACT

Chemical recycling method for polyester based textile and/or packaging waste. In the method, colorless bis hydroxyethyl terephthalate (BHET) is obtained from packaging waste containing polyester and/or textile produced from at least 50% polyester, having at most 50,000 ppm coloring agent or filler material, to be used in the production of packaging materials and/or textile materials such as yarns based on recycled colorless polyethylene terephthalate (PET), fabric, nonwoven (nonwoven fabric). The method also enables the re-production of PET from the BHET.

### TECHNICAL FIELD

The invention is related to a chemical recycling method that enables to obtain colorless bis hydroxyethyl terephthalate (BHET) from packaging waste containing polyester and/or textile produced from at least 50% polyester, comprising at most 50,000 ppm coloring agent or filler material, to be used in the production of packaging materials and/or textile materials such as yarns based on recycled colorless polyethylene terephthalate (PET), fabric, nonwoven (nonwoven fabric) and that enables the re-production of PET from said BHET.

### Prior Art

The usage of polyesters in the textile sector continues to increase day by day. The world's total polyester production in 2018, is 87 million tons and approximately 60% of this is used in the production of polyester yarns and fibres, and the remaining amount is used in packaging and other applications. According to the PCI report published in 2017, the total yarn consumption of the textile sector is 90 million tons and 52 million tons of these yarns are polyester based. Moreover, it is also reported that nowadays only 2% of the textiles are recycled.

The circular economy, which is a new production model based on sustainability and innovation, is gaining importance; where while every waste generated in a production system is re-utilized and raw material costs are minimized, the resource efficiency and environmental benefit are kept to a maximum. Therefore the European commission has published an action plan related to the transition to circular economy in 2015 and immediately after this the commission has published a strategy document related to transition to circular economy in the year 2018. In the year 2019, the European parliament banned some disposable plastics, and set targets related to recycling of PET bottles. According to these targets, it was made mandatory for the year 2025, to include at a percentage of 25%, recycled PET bottles within all PET bottles.

In the prior art, three different methods can be used for recycling of polyesters which are physical/mechanical recycling, semi physical recycling and chemical recycling. Physical/mechanical recycling is frequently used for particularly recycling PET bottles. The collected PET bottles are cleaned with various detergents and following this they sold after being broken down into flakes (small pieces). The impurities such as polyethylene therein are separated by means of density differences. PVC impurities are physically separated to a great extent with PVC detectors. However the PET flakes obtained by physical recycling are not homogenous. It contains particles with different viscosities having different colors and impurities with various micron sizes. A semi physical recycling method is used in order to ensure that the product is more homogenous. The PET flakes are taken into the extruder and are melted and the obtained molten PET is passed through a polymer filter and a cleaner and homogenous polymer is obtained. In this method the final product characteristic is completely dependent on the inputs. When these inputs are colored, the obtained polymer is also colored.

In chemical recycling which is another method, PET is hydrolyzed with monoethylene glycol, methanol or water and it is decomposed into its main monomers. The method of decomposing PET with monoethylene glycol is called glycolysis. In said method, PET is decomposed with monoethylene glycol and it is converted into trimers or higher oligomers of bis hydroxyethyl terephthalate which is a monomer of PET. Following this, these oligomers are passed through various micron sized filters and are re-polymerized. In this chemical recycling method that is also called the glycolysis method, the characteristics of the final product is also dependent on inputs and color separation and purification process is not available in the related process.

In the prior art, substantial studies and research has been carried out in relation to depolymerization processes of polymers such as PET in order to reduce raw material consumption and waste volumes and generally to increase sustainability. Some documents have been reached related to the subject matter in literature. The application numbered JP2000169623A which is one of these documents related to the process of obtaining a polyethylene terephthalate product that is high purity using the waste PET bottles that are collected. In said process, 3,5 hours of depolymerization is carried out with the catalyst of zinc acetate dihydrate at a temperature between 195-200° C. In the depolymerization process 16.6% PET and 83.4% MEG is present. At the end of the reaction, the mixture is cooled to 97° C. and is passed through a 325 mesh filter. The mixture that is cooled to 50° C's afterwards is passed through an activated carbon bed and following this from an anion/cation exchange (ionic resin) bed. Glycol is removed from the mixture at 198° C. and BHET is distilled in a thin film evaporator under 0.5 mmHg pressure at 237° C.

In the patent application numbered JP2008088096A, the colored polyester waste are depolymerized with MEG addition at a ratio of 1:5.6 and are passed through a coarse filter and the materials that are not dissolved are removed from the mixture. The mixture is placed into the thin film evaporator and first of all MEG that has a low volatile point is removed and following this BHET is evaporated in thin film. As a result it is asserted that the color is significantly removed. BHET is dissolved in hot water at a ratio of 1:4 and the coloring agents are reduced by means of reducing agents. At the last stage, the temperature of the aqueous BHET mixture that is passed through the activated carbon column is reduced to 20° C. and the BHET-water mixture is separated from each other. In the latest application it has been mentioned that a vertical centrifuge is used and that separation is carried out with a force of 800 G; however the centrifuge type that is used has not been disclosed in detail. Besides all of this, in the related application the centrifuge is used during the color removing step, and it is used to remove water from BHET.

In the application numbered FR3030541A1, a heterogeneous catalyst is used to perform glycolysis reaction and following glycolysis, it is expressed that the impurities in polyethylene terephthalate can be separated by means of separation methods such as filter, centrifuge, filter press and vacuum filter. In said application, parameters such as the centrifuge type that is used, the temperature, the G force to be applied has not been mentioned. Moreover centrifuge has been mentioned as only one of the separation methods that can be used.

The invention subject to the application numbered EP3577163A1 is related to a depolymerization method that has been developed for condensation polymers that are selected from the group of polyesters, polyamides, polyimides, and polyurethanes, characterized by the usage of transition metal particles as catalysts in the depolymerization of condensation polymers in alcohol. The preferred method for depolymerization of PET polymer is to use a catalyst to achieve an acceptable reaction rate, to heat the condensation polymer and alcohol to high temperatures, to disperse the solid condensation polymer in alcohol, to separate the condensation polymer into oligomers and monomers, to separate the dissolved monomers, dissolved oligomer and undissolved particles from each other. The undissolved particles usually form the transition metal particles and therefore the catalyst. Among other undissolved particles, any kind of pigment available in the solid condensation polymer, a filler, dye and other coloring agents, any kind of oligomer that has not been completely dissolved, and any kind of polymer of different type that has not been depolymerized can be found. In the case of depolymerization of polyesters such as PET ethylene glycol is the preferred alcohol and the suitable temperature is between 180-200° C. The dispersion of the solid condensation polymer and the separation of the condensation polymer into oligomers and monomers can be carried out at the same time. It is believed that the catalyst of this invention accelerates the initial dispersion phase that is probably combined with some depolymerization. Moreover, the catalyst that is used can also be ionically bonded with dye. Although it has been stated that insoluble particles can be separated by centrifugation, filtration or membrane filtration, it is mentioned in the examples given, that separation can be carried out by magnet precipitation. Parameters such as temperature, G force are not given in detail in order to provide colorization and de-colorization by centrifugal separation method.

The invention subject to the document numbered EP0865464 describes the depolymerization of polyesters with a diol followed by the recycling thereof, by dilution in a solution under high temperatures. This dilution under high temperatures enables impurities having sizes larger than 50 μm to be separated by filtration. The solution that is processed is cooled afterwards and the precipitated components are re-polymerized. The filtration phase allows impurities to be removed. The low ratio of the pigments in colored PET, does not enable separation by filtration.

The inventions subject to said applications are generally conducted by taking packaging waste as basis. Textile waste however comprises much higher amounts of coloring agents in comparison to packaging waste. The ratios of the coloring agent are around 100 ppm in packaging while this ratio varies between 1000 ppm and 50,000 ppm in textile. Another problem is that textile products comprise high ratios of chemicals and coating materials. Moreover polyester/cellulosic fibre mixtures are intensely used in textiles. Any kind of method to separate these mixtures from polyester based textiles has not been suggested. The reason for this is that all of the methods that are suggested are related to PET packaging materials. However polyethylene terephthalate is vastly used in the textile sector.

Besides all of this, the technologies used in the prior art, are used to separate the colors of PET bottles that contain low coloring agents such as 100 ppm and these technologies necessitate high energy consumption and high chemical costs.

As a result due to the deficiencies and disadvantages mentioned above, the requirement for a novelty in the related technical field has risen.

### Aim of the Invention

The present invention is related to a chemical recycling method for polyester based textile and/or packaging waste which meets all of the above mentioned requirements, eliminated all of the disadvantages and brings about further advantages.

The main objective of the invention is to provide a method that allows the production of textile materials or packaging materials such as colorless PET yarn, textile, nonwoven (nonwoven fabric) from recycled materials that have been recycled from packaging waste and/or polyester based textiles that comprise high amounts of fillers and coloring agents.

The aim of the invention is to remove paint and other impurities from waste material in the BHET-MEG mixtures obtained following depolymerization of polyester-based textile and/or packaging wastes in the presence of a catalyst with glycol such as monoethylene under the process parameters determined by a disc type centrifugal separator.

The aim of the invention is to separate cellulosic materials such as cotton from the BHET-MEG mixture obtained as a result of depolymerization, by the aid of a filter.

The aim of the invention is to produce colorless PET yarn from recycled polyester based colored packaging waste.

The aim of the invention is to produce colorless PET yarn from recycled textile waste comprising a maximum of 50,000 ppm coloring agent.

The aim of the invention is to provide a method that enables the separation of solvent and dispersed dyes having a molecular size of 300 g/mol and above from the textile products with a disk-type centrifugal separator.

The aim of the invention is to provide a method that enables the separation of said pigment or filler material from textile products that contain maximum 50,000 ppm pigments or filler material using a disk-type centrifugal separator.

The aim of the invention is to provide a method that enables the separation of said pigment or filler material from polyester packaging products that contain maximum 50,000 ppm pigments or filler material using a disk-type centrifugal separator.

Another aim of the invention is to provide maximum separation of the paint from the BHET-MEG mixture that is obtained by depolymerizing polyester-based waste materials with monoethylene glycol, while adjusting the disk type centrifugal separator's G force value, exit temperature and duration to the most suitable level in order to ensure minimum precipitation of BHET.

Another aim of the invention is to develop a process by which polyester based textiles and packaging waste can be recycled together or separately.

In order to reach the aims mentioned above, the invention is a chemical recycling method that enables to obtain colorless bis hydroxyethyl terephthalate (BHET) from packaging waste containing polyester and/or textile produced from at least 50% polyester, comprising at most 50,000 ppm coloring agent or filler material, to be used in the production of packaging materials and/or textile materials such as yarns based on recycled colorless polyethylene terephthalate (PET), fabric, nonwoven (nonwoven fabric), comprising the following process steps;
a. monoethylene glycol (MEG) at the ratio of 2:1-7:1 and said packaging waste is transferred into a depolymerization reactor,
b. preferably zinc acetate or sodium hydroxide is added into the reactor as a catalyst and the reaction is kept for 5 hours at a temperature of 180-270° C. and following this the BHET-MEG mixture containing a coloring agent is obtained,
c. feeding the BHET-MEG mixture cooled below a temperature of 50° C. in order to separate BH ET from MEG into the decanter separator that has a G force adjusted to a range of 1000-9000×g or into a horizontal vacuum belt filter or filter press,
   characterized in that during the steps of b and c, the following process steps are carried out,
in the case that BHET-MEG mixture contains cotton, the mixture is passed through a filter at a temperature within the range of 50-190° C. and the cotton is removed from the medium,
feeding said mixture into a disk type centrifuge having a two phase separation system, that has a G force value adjusted at a range of 1000-12000×g, having an exit temperature of 120±60° C., in order to ensure maximum separation of the coloring agent from the mixture,
separating from the centrifuge separator the BHET and MEG mixture as the liquid phase and an amount of BHET and dye as the solid phase.
mixing the BHET-MEG mixture in the heating tank at a temperature of 120±60° C. for 30 minutes in order to dissolve the partially re-crystallized BHET inside MEG following centrifuge,
mixing the mixture for 45 minutes at a temperature within the range of 120±60° C. by adding powdered activated carbon at a range of 1-10× of the dye to the mixture or passing the mixture through an activated carbon column,
feeding said mixture into a disk type centrifuge, that has a G force value adjusted at a range of 1000-12000×g, having an exit temperature of 120±60° C., in order to ensure maximum separation of the activated carbon as the solid phase from the BHET-MEG mixture,
passing the BHET-MEG mixture that is separated as the liquid phase through a filter and delivering it into the cooling tank.

All of the structural and characteristic features of the invention and its advantages shall be clearly understood by means of the detailed description given below and therefore if any kind of evaluation is to be carried out, it needs to be done so by taking into consideration this detailed description.

### DETAILED DESCRIPTION OF THE INVENTION

In this detailed description the chemical recycling method for polyester based textile and/or packaging waste is described with examples that shall not limit the scope of the invention and which have been intended to only clarify the subject matter of the invention.

The invention is related to a chemical recycling method that enables to obtain colorless bis hydroxyethyl terephthalate (BHET) from packaging waste containing polyester and/or textile produced from at least 50% polyester, comprising at most 50,000 ppm coloring agent or filler material, to be used in the production of packaging materials and/or textile materials such as yarns based on recycled colorless polyethylene terephthalate (PET), fabric, nonwoven (nonwoven fabric).

In the method subject to the invention, recyclable textile products can contain a maximum of 50% cotton or other cellulosic fibers. The ratios of the coloring agent within the polyester based packaging are around 100 ppm while this ratio varies between 1000 ppm and 50,000 ppm in textile products. The waste materials that are mentioned can comprise pigments as coloring agents, a solvent dye dissolved in polymer or dispersed dye.

Solvent dyes and disperse dyes are high solubility dyes in polyester and monoethylene glycol, and they generally remain as significantly dissolved rather than particles inside the polymers to which they are added to. In order to carry out the method subject to the invention, the highly soluble solvent and disperse dyes must have a molecular size of 300 g/mol and above. The pigments and filler materials however, are available inside the polymer as particles.

In the preferred embodiment of the invention, the waste materials that can be used to produce recycled colorless polyethylene terephthalate (PET) based yarns and/or packaging materials, can comprise solvent blue 122, solvent blue 104, solvent brown 53, solvent green 3, pigment black 7, pigment blue 15:1, pigment blue 15:3 or pigment green 7 as coloring agents.

The Chemical Recycling Method Subject to the Invention is as Follows;
Monoethylene glycol (MEG) at the ratio of 2:1-7:1 and textile and/or polyester based packaging waste , made of at least 50% polyester material is transferred into a depolymerization reactor,
Preferably zinc acetate or sodium hydroxide is added into the reactor as a catalyst and the reaction is kept for 5 hours at a temperature of 180-270° C. and the depolymerization process is completed,

(In this process step depolymerization reaction can be carried out without using a catalyst)
At the end of the depolymerization process a mixture formed of bishydroxyethylterephthalate (BHET), MEG and a coloring agent is obtained,

(At the end of this process BHET monomer that has a melting point between 90-120° C. and BHET dimer, trimer and oligomer having a melting point within the range of 120-170° C. at maximum 10% is obtained).
The BHET-MEG mixture is filtered at a temperature between 50-190° C. and cotton sourced from the textile product is removed,
The remaining mixture is fed into a disk type centrifuge having a two phase separation system, that has a G force value adjusted at a range of 1000-12000×g, having an exit temperature of 120±60° C., in order to ensure maximum separation of the coloring agent,
BHET and MEG mixture as the liquid phase and the coloring agent and an amount of BHET as the solid phase are separated from the centrifuge separator.
Mixing the BHET-MEG mixture in the heating tank at a temperature of 120±60° C. for 30 minutes in order to dissolve the partially re-crystallized BHET inside MEG following centrifuge,
Powdered activated carbon at a range of 1-10× of the dye is added into the mixture. This mixture is mixed for 45 minutes at a temperature within the range of 120±60° C. or it is passed through the activated carbon column,
The mixture is re-fed into a disk type centrifugal separator and the activated carbon is separated from the BHET-MEG mixture a solid phase by applying 1000-9000×g G force at an exit temperature of 120±60° C., and the BHET-MEG mixture is passed through a filter and is delivered into a cooling tank,
The BHET-MEG mixture is fed into a decanter separator and it is separated from BHET-MEG by applying 1000-6000×g G force at a temperature of 50° C.

In the chemical recycling method of the invention, Alfa Laval type HCHPX 513SGD-35CGRXT or Haus IBA 4021-K40 models can be used as disk type centrifuge and Haus DDI 2342 can be used as a decanter separator. However the disk type centrifuge and decanter separator models are not limited to these.

In a preferred embodiment of the invention AquaSorb™ MP25 can be used as powdered activated carbon.

In a preferred embodiment of the invention, a horizontal vacuum belt filter or filter press can also be used to separate BHET from the BHET-MEG mixture that has been cooled below 10° C.

While the invention enables maximum separation of the dye from the BHET-MEG mixture that is obtained by depolymerizing polyester-based packaging waste and/or textiles that are produced from at least 50% polyester material, with monoethylene glycol, the obtained

BHET-MEG mixture is fed into the centrifugal separator that is utilized for sold-liquid phase separation in order to ensure minimum precipitation of BHET. While the liquid phase consisting of the BHET-MEG mixture exits the liquid phase outlet of the centrifugal separator, the dye is received from the solid phase outlet as the solid phase.

In the chemical recycling method subject to the invention, the exit temperature and G force value of the centrifugal separator having a two-phase separation system are the parameters that provide efficient separation. These parameters allow the dye to be separated from the BHET-MEG mixture at a maximum rate and they also enable minimum precipitation of BHET during this separation process. The exit temperature of the centrifugal separator having a two-phase separation system is set to 120±60° C. before the separation process begins, and the G force value is adjusted to the range of 1000-12000×g.

The mixture that is fed into the centrifugal separator having a two-phase separation system consists of 20% BHET monomer, 78.5% MEG and 0.3% dye. At the end of the centrifuge process, the BHET-MEG mixture that is separated as liquid phase is formed of 20.4% BHET monomer and 79.6% MEG. The part that is separated as the solid phase can vary between 2-5%. 5-10% of the part separated as solid phase consists of coloring agents, 70% is MEG and 20-25% is BHET monomers, dimers, trimers and oligomers.

In a preferred embodiment of the invention a centrifugal separator system having a three phase separation system that can separate three phases at the same time (solid-liquid-liquid) can also be used. In this system, it must be noted that the exit temperature should be minimum 115° C. By means of this system BHET, MEG and the coloring agent is separated in one step. BHET and MEG are separated as liquid phase by density difference and the dye is separated as the solid phase. BHET and MEG are separated as liquid-liquid due to their density differences.

The BHET-MEG mixture obtained as a result of depolymerization reaction is fed into the disc-type three-phase centrifugal separator whose exit temperature is adjusted to 160±40° C., and the G force value is adjusted between the ranges of 1000-12000×g. BH ET and MEG as the liquid phase the coloring agent and an amount of BHET as the solid phase are separately separated from the centrifuge separator. At the last step, powdered activated carbon is added into the dye at a range of 1-10× to the BHET phase and the mixture is mixed for 45 minutes at 120±60° C. or the BHET phase is passed through an activated carbon column.

### EXAMPLE 1

Fabric features; 100% polyester based fabric comprising 1.5% pigment

Glycolysis Reaction (Depolymerization)

First of all 21875 gr monoethylene was placed into the reactor and following this 3125 gr polyester fabric has been added into the reactor.

15.6 g sodium hydroxide was fed. The temperature was set to 230° C. The pressure is between 3.0-3.5 bars at this temperature. The mixture was kept for 5 hours under these conditions. Following this the pressure was made atmospheric and glycol was collected. The pressure dropped and therefore the temperature dropped down to 195° C. Due to the glycol collected from the last mixture, the % amount of bishydroxyterephthalate increased to 20%.

As a result of the glycolysis reaction 97% mono BHET, 3% dimer, timer and oligomer was obtained. The obtained BHE had a melting point of 110° C.

Color Separation by Means of Centrifuge

Sigma 2-6 compact centrifuge has been used as a centrifuge. The 21 kg BHET-MEG dye mixture produced during the depolymerization step, has been fed into the centrifuge under different conditions. The conditions mentioned are given in detail below.

Examination of the G Force Value Effect on Color Separation Performance

The sample prepared in Example 1 was heated and was subjected to a centrifuge process at different revolutions for 3 minutes by keeping the final sample temperature in the range of 70-130° C. Under these conditions, % amount remaining at the bottom of the tube and the amount of BHET that has precipitated in this section was measured. At the same time the color intensity of the supernatant was measured. The color intensity has been measured with the datacolor SF 600 X device. As reference 500 ppm Pigment Red 214 has been prepared inside monoethylene glycol. The sample was heated to 80° C. and the % color intensities of the supernatants of the sample are measured according to temperature reference, and the effect of the G force parameter on color separation is given in table-1.

TABLE-1
Affect of the G force parameter on color separation

| | | Exit | | Unprecipitated |
|---|---|---|---|---|
| | Speed | Temperature | | section |
| G force (xg) | (rpm) | (° C.) | % BHET Loss | % Color Intensity |
| 1459 | 3000 | 116 | 3.6 | 16.27 |
| 648 | 2000 | 120 | — | 30.3 |
| 1459 | 3000 | 118 | 3.63 | 15.4 |
| 2594 | 4000 | 115 | 5.76 | 10.2 |

As it can be understood from the information given in Table 1, as G force increases the color of the supernatant decreases.

Examination of the Centrifuge Exit Temperature Effect on Color Separation Performance

The samples were centrifuged at different temperatures by leaving them to wait for 3 minutes at 3000 rpm speed (1459 xg G force). The effect of the exit temperature of the centrifuge to color separation has been given in table-2.

TABLE-2
Effect of the exit temperature of the centrifuge to color separation

| | | % Color Intensity at |
|---|---|---|
| Temperature | | the Un-precipitated section |
| (° C.) | % BHET Loss | (according to 500 ppm Red 214) |
| 120 | 4.25 | 16.27 |
| 90 | 6.42 | 18.73 |
| 80 | 7.44 | 66.58 |
| 70 | 6.17 | 62.60 |
| 60 | 6.42 | 95.64 |
| 50 | 5.64 | 97.05 |

As it can be understood from the information given in Table-1, as the temperature falls, the precipitation rate of the coloring agents is reduced. Moreover it has been observed that more amounts of BH ET crystallizes and precipitates as the temperature falls.

Conditioning

As a result of the centrifuge separation process, the mixture separated from the dye and impurities was mixed for 30 minutes at 120° C. in a mixer beaker and it has been enabled for BHET to be completely re-dissolved in MEG.

Color Separation with Activated Carbon

1.2% powdered activated carbon called Aquasorb MP 25 was added to the conditioned mixture. The mixture was mixed for 45 minutes at 120° C. Following this, the mixture was centrifuged at 3000 revolutions for 3 minutes at a G force of 1459 such that the exit temperature is 90° C. The activated carbon has been separated from the mixture. The activated carbon particles at ppm level that have not been separated are passed through a 1 micron filter and were separated at 90° C.

Separation of the BHET-MEG Mixture

The BHET-MEG mixture has been cooled to 10° C. and colorless solid form BHET was obtained from a 3000 rpm (1459×g G force) centrifuge.

### EXAMPLE 2

Fabric features; 70% polyester and 30% cotton based fabric comprising 1.5% pigment Red 214

Glycolysis Reaction (Depolymerization)

First of all 21875 gr monoethylene was placed into the reactor and following this 3125 gr fabric has been added into the reactor. 15.6 g sodium hydroxide was fed. The temperature was set to 230° C. The pressure is between 3.0-3.5 bars at this temperature. The mixture was kept for 5 hours under these conditions and following this the pressure was made atmospheric and glycol was collected. The pressure dropped and therefore the temperature dropped down to 195° C. Due to the glycol collected from the last mixture, the % amount of bishydroxyterephthalate increased to 14%.

The mixture was passed through a 1000 micron metal filter and cotton was separated and the other processes were carried as in example 1.

### EXAMPLE 3 (INDUSTRIAL SIZE TRIAL)

Fabric features; 100% polyester based fabric comprising 1.5% pigment Red 214

Glycolysis Reaction (Depolymerization)

First of all 4375 kg monoethylene glycol was placed into the reactor and following this 625 kg polyester fabric has been added into the reactor. 3.125 kg sodium hydroxide was fed. The temperature was set to 230° C. The pressure is between 3.0-3.5 bars at this temperature. The mixture was kept for 5 hours under these conditions and following this the pressure was made atmospheric and glycol was collected. The pressure dropped and therefore the temperature dropped down to 185° C. Due to the glycol collected from the last mixture, the % amount of bishydroxyterephthalate increased to 19%.

Color Separation by Means of Centrifuge

The product cooled in the reactor to 90-95° C. was pressed into a disk type centrifuge called IBA 4021-K40. The BHET-MEG dye mixture produced at the depolymerization phase was fed. The centrifuge was operated at 9000 G force. The time the mixture was kept in the centrifuge was calculated to be approximately 30 seconds. The color intensity of the obtained BHET MEG mixture was measured as 16.5%.

Conditioning

As a result of the centrifuge separation process, the mixture separated from the dye and impurities was mixed for 30 minutes at 120° C. by being re-fed into the reactor, and it has been enabled for BHET to be completely re-dissolved in MEG.

Color Separation with Activated Carbon

1.2% powdered activated carbon called Aquasorb MP 25 was added to the conditioned mixture. The mixture was mixed for 45 minutes at 120° C. Following this, the mixture was fed at 95° C. into a Haus IBA 4021-K40 centrifugal separator separation at 9000 xg G force from the activated carbon was performed. The trace amount of activated carbon particles suspended was passed through a 1 micron filter and was separated at 90° C.

Separation of the BHET-MEG Mixture

The BHET-MEG mixture was cooled to 10° C. The mixture was taken from the reactor and placed into a Haus DDI 2342 decanter type separator. 6000 xg G force was applied and BHET-MEG was separated and colorless solid form of BHET was obtained.

BHET Monomer Polymerization

17.4 kg from the obtained BHET monomer was taken and it has been loaded into a 40 lt volume pilot reactor. The reactor temperature was adjusted to 240° C. and the mixing speed was adjusted as 10 hz. After 30 minutes the mixing speed was adjusted to 50 hz value. When the temperature reached 135° C., 4.4 gr antimony in 600 gr MEG and 0.84 gr H₃PO₄ was fed into the reactor. After 50 minutes the reactor temperature was adjusted to 270° C. When the reactor temperature reached 260° C. after 1 hour, the vacuum that was adjusted to decrease to 1 mbar in 77 minutes was started. The final temperature was applied as 288° C. The IV value of the PET obtained was measured as 0.672 dl/g; and the amount of % DEG was measured as 0.78 and the number of carboxyl end groups were measured as 17.70 eq/ton. The L color of the obtained polymer was measured as 61.77, color a as −1.16 and color b as 10.6.

The polymer that was produced was tested in a Collin FT E20T-MP-IS test device, according to the EN 13900-5 standards. The filter test result measured 0.117 bar/g in a 5 micron filter.

The produced polymer was dried under vacuum of 13 mbars at 160° C. for 4 hours, and using this polymer, 3.5 denier yarn was produced at 285° C. in the pilot yarn machine called Busschaert B-8540. The L color of the produced yarn was measured as 91.75, color “a” was −0.39 and color “b” was 2.89.

In present applications, whereas only colorless PET yarn from polyester materials can be obtained comprising ppm levels of pigments as coloring agents from only clear PET bottles by means of chemical recycling; by using the method of the invention, colorless BHET has been able to be produced in order to obtain colorless PET yarn and/or packaging material via chemical recycling from textile products and/or polyester based packaging waste made of at least 50% polyester material.

By means of the centrifuge parameters determined in the method of the invention, the coloring agents inside the textile products and polyester based packaging waste can be separated at a maximum amount at the solid phase. Besides this, by means of a filtering process, cotton can be separated which is available in the medium as an impurity and which is sourced by the textile product.

During the use of an activated carbon column in the method of the present invention, unlike the existing applications, BHET is fully dissolved inside MEG in a conditioning tank to ensure that BHET is re-dissolved after the centrifugation process and to prevent BHET from adhering to the activated carbon column. In the preferred embodiment, powdered activated carbon can be included in the system instead of the activated carbon column. Following this process, the activated carbon can be separated by a centrifugal separator.

1. A chemical recycling method that enables to obtain colorless bis hydroxyethyl terephthalate (BHET) from packaging waste containing polyester and/or textiles produced from at least 50% polyester, comprising at most 50,000 ppm coloring agent or filler material, to be used in the production of packaging materials and/or textile materials such as yarns based on recycled colorless polyethylene terephthalate (PET), fabric, nonwoven (nonwoven fabric), the method comprising the following process steps:
a) monoethylene glycol (MEG) at the ratio of 2:1-7:1 and said packaging waste is transferred into a depolymerization reactor,
b) preferably zinc acetate or sodium hydroxide is added into the reactor as a catalyst and the reaction is kept for 5 hours at a temperature of 180-270° C. and following this the BHET-MEG mixture containing a coloring agent is obtained,
c) feeding the BHET-MEG mixture cooled below a temperature of 50° C. in order to separate BHET from MEG into the decanter separator that has a G force adjusted to a range of 1000-9000×g or into a horizontal vacuum belt filter or filter press,
characterized in that during the steps of b and c, the following process steps are carried out:
in the case that BHET-MEG mixture contains cotton, the mixture is passed through a filter at a temperature within the range of 50-190° C. and the cotton is removed from the medium,
feeding said mixture into a disk type centrifuge having a two phase separation system, that has a G force value adjusted at a range of 1000-12000 xg, having an exit temperature of 120±60° C., in order to ensure maximum separation of the coloring agent from the mixture,
separating from the centrifuge separator the BHET and MEG mixture as the liquid phase and an amount of BHET and dye as the solid phase,
mixing the BHET-MEG mixture in the heating tank at a temperature of 120±60° C. for 30 minutes in order to dissolve the partially recrystallized BHET inside MEG following centrifuge,
mixing the mixture for 45 minutes at a temperature within the range of 120±60° C. by adding powdered activated carbon at a range of 1-10× of the dye to the mixture or passing the mixture through an activated carbon column,
feeding said mixture into a disk type centrifuge, that has a G force value adjusted at a range of 1000-12000 xg, having an exit temperature of 120±60° C., in order to ensure maximum separation of the activated carbon as the solid phase from the BHET-MEG mixture, and
passing the BHET-MEG mixture that is separated as the liquid phase through a filter and delivering it into the cooling tank.

2. A method according to claim 1, wherein said coloring agent has a maximum ratio of 50,000 ppm.

3. A method according to claim 1, wherein said coloring agent is a pigment, solvent dye or disperse dye.

4. A method according to claim 3, wherein the molecular weight of the solvent dye is at least 300 g/mol.

5. A method according to claim 3, wherein the molecular weight of the disperse dye is at least 300 g/mol.
